(19) United States
(12) Patent Application Publication
(10) Pub. No.: US 2006/0283931 A1
(43) Pub. Date: Dec. 21, 2006

(54) Product authentication

(75) Inventors: James E. Polli, Ellicott City, MD (US); Stephen W. Hoag, Baltimore, MD (US)

Correspondence Address: FOLEY AND LARDNER LLP;SUITE 500, 3000 K STREET NW, WASHINGTON, DC, 20007, US

(73) Assignee: University of Maryland, Baltimore

(21) Appl. No.: 11/399,600

(22) Filed: Apr. 7, 2006

Related U.S. Application Data
(63) Continuation-in-part of application No. PCT/US04/30977, filed on Sep. 22, 2004.
(63) Continuation-in-part of application No. 10/572,912.
(60) Provisional application No. 60/504,774, filed on Sep. 22, 2003.

(51) Int. Cl. G06F 19/00

(52) U.S. Cl. 235/375

(57) ABSTRACT

A method is disclosed to verify and identify products through their product signatures in order to combat counterfeiting and reduce dispensing errors, using methods such as spectral analysis (e.g., near infrared spectroscopy). Furthermore, in order to actively evade product counterfeiting, a method is disclosed where an amount of one or more components of the product are varied (e.g., over time); the variation provides a different product signature, but falling within a desirable or necessary range.

### CROSS-REFERENCE TO RELATED PATENT APPLICATIONS

This application is a continuation-in-part of the U.S. National Phase application Ser. No. 10/572,912 filed on Mar. 21, 2006 which claims priority to international application No. PCT/US2004/030977 filed on Sep. 22, 2004 which claims priority to U.S. provisional application 60/504,774 filed on Sep. 22, 2003, the disclosures of which are incorporated by reference herein in their entirety.

### BACKGROUND OF THE INVENTION

1. Field of the Invention

This invention relates generally to a method for assuring product identity as a product is distributed from the manufacturer to the retailer and to end-users or consumers. This invention allows for the active evasion of the counterfeiting of products.

Within the distribution system of products, there is a need to assure product identity. Example scenarios include the need to identify and differentiate authentic and counterfeit products, and a need to assure the distribution of the correct product to retailers and others from distribution or manufacturing sites. There also exists the need to authenticate the manufacturer of products after they leave the manufacturing facility, such as when a product is allegedly involved in causing injury or damage to a person, thing, or other entity.

Product counterfeiting is a significant and growing world-wide problem. For example, in the specific example of drug products, there are about 9 billion subscriptions filled worldwide each year; about 3 billion of which are filled in USA alone. It has been estimated that about 10 to 50 percent of prescription drugs in certain countries of Asia, Africa, and South America may be counterfeit. The number of counterfeit drug cases being investigated by the FDA has quadrupled and includes such well known drugs as Lipitor, Procrit, Neupogen, Serostim, Zyprexa, Viagra, and Evra. Drugs are now purchased in increasing quantities over the Internet and from Canadian and Mexican pharmacies making source and drug identification even harder.

In “Combating Counterfeit Drugs: A Report of the Food and Drug Administration”, a number of different technologies to prevent counterfeiting are discussed, such as multi-pronged approaches utilizing tag technologies (e.g., track-and-trace), pedigree papers, an electronic package code (EPC), bar codes, radio frequency ID (RFID), special inks, holograms, strengthening state licensure requirements for wholesale distributors, and continuing development and implementation of secure business practices. Also discussed is requiring manufacturers to sell products only to wholesalers who only directly purchase from the manufacturer and requiring manufacturers to publish the names of their wholesalers on their Web sites.

In addition to problems of counterfeiting, with the increasing number of prescriptions being filled, there is an increased chance for prescription error. While these errors may take many forms, the likelihood of a dangerous or life threatening “adverse drug event” increases proportionally with the increased chance of prescription fill error. Several studies have shown that prescription error rates are consistently in the 2% to 7% range, with a 4% error rate often cited as a reliable average.

Many systems have been devised to apply identifying markers to products, such as color, size and shape distinctions among different products or on the same product from different manufacturers. Identification markers applied to products are typically discernible to a prospective counterfeiter and can therefore be reproduced by the counterfeiter in many cases.

One of the problems confronting marking systems relating specifically to drug products is the need to provide unadulterated drugs, i.e., drugs that the FDA considers to be subject to federal guidelines and which meet those guidelines. Thus, the addition of marker substances to a drug dosage form, although not discernable without sophisticated analysis procedures, must meet regulatory approval and is typically subject to onerous reporting requirements. Furthermore, counterfeiters can also analyze the drug product for the presence of the marker and thereafter duplicate the marker containing drug product.

Thus, there exists an unfulfilled need for a product identification system which is covert, which is within regulatory guidelines, if applicable, and which can quickly determine the source and/or identity of the product as to manufacturer, including the production lot, and which, optionally, may be maintained in confidence from the identification system user. Ideally, the identification system is a dynamic system that changes over time, thereby rendering efforts to break the system even more unlikely to be successful.

2. Description of Related Art

Color, shape size and external markings have long been used to identify products to be used in conjunction with external container labeling schemes.

In the specific area of pharmaceutical drug products, there are examples of overt drug labeling systems known to the art. Baum, U.S. Pat. No. 4,918,604, describes a drug labeling and prescription filing system. The system identifies the dispensed drug to be identified via a color photograph of the drug on its packaging. An example using a combination of overt methods is disclosed in Wootton, U.S. Pat. No. 6,535,637 and entitled Pharmaceutical Pill Recognition and Verification System. The system utilizes a combination of coloration, shape, size and other surface features of the pill or tablet. A scheme using covert identification of a drug by spectral means is disclosed in Soloman, U.S. Pat. No. 5,679,954 entitled Non-Destructive Identification of Tablet Dissolution by Means of Infared Spectroscopy and U.S. Pat. No. 5,900,634 entitled Real-Time On-Line Analysis of Organic and Non-Organic Compounds for Food, Fertilizers, and Pharmaceutical Products. Soloman provides an apparatus for infrared spectroscopy using a succession of collimated light beams throughout the middle and near infrared spectrum. These beams are impinged against the sample and the diffuse component of the reflected light is measured throughout the spectrum. Finally, the light received is analyzed by a neutral network to determine the sample characteristics.

Also in the field of drug products, Rzasa et al., U.S. Pat. No. 6,771,369. entitled System and Method for Pharmacy Validation and Inspection, discloses an apparatus for verifying the identity of a dispensed pharmaceutical. An analysis unit adapted to determine a property of the dispensed pharmaceutical, an input device adapted to receive predetermined identifying information corresponding to the dispensed pharmaceutical, and a comparison unit adapted to compare the determined property of the dispensed pharmaceutical with the predetermined identifying information. Rzasa et al. also discloses a method of verifying a prescription, wherein the prescription comprises a pharmaceutical compound, by associating the prescription with a unique identifier, storing the unique identifier, determining the identity of the pharmaceutical compound, and comparing the identity of the pharmaceutical compound with the unique identifier.

### SUMMARY OF THE INVENTION

This present disclosure uses electromagnetic spectroscopy, to verify and identify products through their product signatures, which arise from the products' unique interaction with electromagnetic radiation. The method of identifying a product's “signature” includes but is not limited to near infrared spectroscopy (NIR), raman spectroscopy, laser induced Floresence (LIF), and terahertz spectroscopy. A method is disclosed where an amount of one or more of ingredients of the product are varied, e.g., over time; the variation providing a different product signature. Preferably, any such variation falls within a level deemed permissible by a regulatory body, if applicable (e.g., FDA, OSHA, EPA, WHO, trade group or other governmental or private body). This method results in the covert inclusion of unique product signatures that can be changed (e.g., over time) between batches of product, resulting in an authentication system that is difficult to deceive by potential counterfeiters.

The marking system is covert since the authentication system employs a product's spectral characteristics, e.g., its NIR absorption spectrum or any derivative (e.g., second derivative) thereof. The marking system is inherent in the product itself, is present in any form of the product, and cannot be modified after manufacture. Preferably, ingredients (e.g., active or inert ingredients) in the product formulation are changed over time. The spectral signature of the product formulation is determined by the manufacturer (i.e., the reference spectral signature) or a third party vendor setup for such purposes. An unknown sample has its spectral signature compared to the reference spectral signature. (It is understood that raw data from a spectral signature can optionally be analyzed or further processed to arrive at an output that embodies the distinctive “signature” attributable to a particular product or batch thereof.) The match or lack of match of the two spectral signatures determines whether or not the form of product was produced by that manufacturer, and, if produced by that manufacturer, which batch, lot, plant, manufacturing line, or time of manufacture, etc. the set of product forms the sample belongs to.

The present method allows a manufacturer to “fingerprint” or “authenticate” a selected quantity of manufactured product, be it by batch, by production location, by production line, by date of manufacture, etc. The word “authenticate” as used herein refers to analysis based on a parameter or set of parameters associated with a product that allows an observer to determine some fact relating to the product and thereafter to compare that fact to a reference standard. Information developed may be used to identify the product, a key ingredient, an excipient, an origin, dosage or strength or purity level, and the like.

Due to its flexibility in determining the origin of product forms manufactured with a single product signature, the manufacturer can use the methods of the present invention for quality assurance, quality control, or other internal or external control purposes. The product signature can be used in conjunction with packaging information to confirm lots, batches or any other identifying information as the product moves through the supply chain.

In a particular embodiment of the invention, these benefits are obtained, by way of illustration, by verifying and/or determining identity of pharmaceutical products within a drug product distribution system, and are achieved though but are not limited to the use of NIR spectroscopy,-optionally in connection with one or more other technologies. The combination of these techniques and approaches make for a rapid and accurate approach to assure drug and drug product identity, as well as a method to prevent the pharmaceutical product from being counterfeited.

The methods of the present invention are equally applicable to other multi-component products that are amenable to formulation and, in particular, formulations that can be varied without substantially affecting the performance of the formulated product—while generating unique spectral characteristics for each formulation. Preferably, such finished formulations are further receptive to analysis by spectral means, more preferably, by such spectral means as are described herein or are readily apparent to one of ordinary skill.

This invention entails the identification or verification of a multi-component product through the embedding of a spectral fingerprint. Formulated, multi-component product means the material is at least semi-processed and is the result of incorporating at least two components together.

In practice, application of the invention is advantageous for products that would benefit from being identified or whose identity would benefit from being verified. For example, products that are suspected to be counterfeited are candidates (e.g. clothing). Products that are susceptible to being sold on a “grey market” are also candidates (e.g. pharmaceuticals). Products that would benefit from identify verification due to safety concerns are also candidates (e.g. one sound-a-like drug versus another, one type of petroleum product versus another).

Examples of products that are amenable to formulation and subsequent analysis include pharmaceuticals, food, baby formula, medical devices, pesticide products, jewelry, textile, apparel, shoes, purses and other designer fashion items, cosmetics, paint, nutraceuticals (e.g. fish oils), perfumes, sunglasses, auto parts, aircraft parts, and plastics, including products containing plastic (e.g. cell phone covers, toys, credit or debit cards).

Deaths have occurred due to counterfeit autoparts (e.g. brake pads) and counterfeit aviation parts. Counterfeit baby foods and toys resulted in serious problems for children. Counterfeit clothing can be unsafe (e.g. not flame retardant). Counterfeit sunglasses may not be shatterproof or provide ultraviolet protection. Counterfeit extension cords, as well as counterfeit power-supply cords, telecommunications wire and cable, outlet boxes, switches, and ground-fault circuit interrupters, pose electrical risk.

In particular, petroleum products are amenable to spectral analysis, Petroleum products or byproducts, such as fuels or fuel derivatives including but not limited to motor gasoline, diesel and distillate fuel oil, liquefied petroleum gas, jet fuel, residual fuel oil, kerosene, and coke; finished non-fuels petroleum products or by products thereof, including but not limited to solvents, lubricating oils, greases, petroleum wax, petroleum jelly, asphalt; petrochemical feedstocks or byproducts thereof, including but not limited to naptha, ethane, propane, butane, ethylene propylene, butylenes, butadiene, benzene, toluene, and xylene.

This invention entails formulating spectra signature into product, through the formulation of the product. Hence, the product must be multi-component in composition. For example, components in pharmaceutical products are various types of excipients (e.g. filler, binder, lubricant). Components in petroleum products can include oxygenates and/or components remaining after some level of processing or refining. Components in plastic include flame retardants, curing agents and antioxidants, as well as components to aid color retention, lubrication, clarity, strength, weather and chemical resistance, and polymer processing.

The methods also provide an efficient technique for fingerprinting products as to the manufacturer and production batch. Most significantly, the techniques disclosed provide for systems and methods of manufacturing a unique fingerprint that serves as a label or product signature inherent in each product or batch thereof. Advantageously, the reference product signature is selectively disclosed and easily coordinated through the manufacturer of the product or its designee.

The herein disclosed approach can be implemented by applying a spectral technique (e.g., NIR spectroscopy) with a manufacturing method that provides for a dynamic tagging system. Future tags cannot be anticipated or readily deciphered because formulation component(s) themselves provide the tag.

In certain embodiments, the manufacturing method complies with regulatory mechanisms in place at the time of manufacture to minimize regulatory review or reporting requirements. The method may be modified as regulatory or equipment changes occur to maintain or increase the number of signatures that may be used.

In a particular embodiment of the invention, NIR spectroscopy is advantageous in terms of time and disposables. NIR spectroscopy is noninvasive and nondestructive. Analysis times are very short (e.g., 1 sec) and additional reagents are not required. The procedure is highly sensitive and is able to perform multi-component analyses, as disclosed herein. Moreover, the disclosed procedures require little, if any, sample preparation.

In one of its various embodiments, the present invention is a method of labeling an article of manufacture having one or more components and/or ingredients comprising varying an amount of at least one of the one or more components and/or ingredients over time and generating a product signature. of the product having the varied amount of the at least one of the one or more components and/or ingredients.

The present invention includes a batch identification method for determining the source of a product from among a plurality of production batches of the product, where the product has one or more active ingredients and one or more inactive ingredients, comprising changing an amount of at least one of the one or more active or inactive ingredients among different batches of the pharmaceutical product produced, the variation being at least sufficient to distinguish the difference in the NIR spectra of product produced in each batch.

Also disclosed is a system for verifying the authenticity of a product comprising the steps of: manufacturing more than one batch of a product, each batch having a reference spectral signature; inputting each of the reference spectral signatures into a database; scanning a sample product to produce a scanned spectral signature; comparing the scanned spectral signature to each of the reference spectral signatures; and reporting the results of the comparison, wherein the authenticity of the sample product is verified by the scanned spectral signature being equivalent to at least one of the reference spectral signatures.

In another of its embodiments the invention comprises a set of groups of a product having one or more active ingredients and one or more inactive ingredients, wherein the one or more active ingredients and the one or more inactive ingredients are the same in each group in the set, and an amount of at least one of the one or more active or inactive ingredients is different in at least one group of the set as compared to the other groups in the set, wherein the amount is detectable in a near-infrared (NIR) spectra of the product in the at least one group of the set as compared to a near-infrared (NIR) spectra of the product of the other groups of the set. It is understood, however, that in the specific case of pharmaceutical products, it is desirable, if not necessary, to vary an amount of only the one or more inactive ingredients.

As used in this disclosure, a “set” of groups of products means a plurality of groups where each group is related to the other groups in the set by having the same components (or active and inactive ingredients, as the case may be) present in the product, each group being distinguished from other groups in the set by having varying amounts of one or more of the components (or active and inactive ingredients, as the case may be) in the product.

In a particular embodiment of the invention member[s] of a set of groups of a pharmaceutical product are provided having one or more active ingredients and one or more inactive ingredients, wherein the one or more active ingredients and the one or more inactive ingredients are the same in each group in the set, and an amount of at least one of the one or more inactive ingredients is different in at least one group of the set as compared to the other groups in the set, wherein the amount is detectable in a near-infrared (NIR) spectrum of the pharmaceutical product in the at least one group of the set as compared to a near-infrared (NIR) spectrum of the pharmaceutical product of the other groups of the set.

In yet another embodiment, the present invention is a method of manufacturing a labeled pharmaceutical product having one or more active ingredients and one or more inactive ingredients comprising modifying the quantity of at least one of the one ore more inactive ingredients in a first pharmaceutical product to make a second pharmaceutical product, wherein the modification is detectable in an near-infrared (NIR) spectrum of the second pharmaceutical product as compared t a near-infrared (NIR) spectrum of the first pharmaceutical product, wherein said second pharmaceutical product is the labeled pharmaceutical product.

The present invention further includes a labeling system for a product having multiple components comprising modifying a quantity of at least one of the multiple components in a first product to make a second product, wherein the modification is detectable in a near-infrared (NIR) spectrum of the second product as compared to a NIR spectrum of the first product, wherein the modification comprises the label.

In yet another of its various embodiments, the present invention discloses a method of determining the identify of a product comprising the steps of obtaining a product signature of said product and comparing said product signature to a reference product signature of a reference product, wherein said reference product signature is a member of a library, wherein the product is identified as the reference product if the product signature of the product is the same as the reference product signature.

### BRIEF DESCRIPTION OF THE DRAWINGS

FIG. 1 contains Table 1. Level 1 Component and Composition Changes for Immediate Release Oral Solid Dosage Forms and Table 2. Level 2 Component and Composition Changes for Immediate Release Oral Solid Dosage Forms

FIG. 2 contains Table 3. Level 3 Component and Composition Changes for Immediate Release Oral Solid Dosage Forms and Table 4. Level 1 Component and Composition Changes for Modified Release Oral Solid Dosage Forms (nonrelease controlling excipient)

FIG. 3 contains Table 5. Level 2 Component and Composition Changes for Modified Release Oral Solid Dosage Forms (nonrelease controlling excipient) and Table 6. Level 3 Component and Composition Changes for Modified Release Oral Solid Dosage Forms (nonrelease controlling excipient)

FIG. 4 contains Table 7. Level 1 Component and Composition Changes for Modified Release Oral Solid Dosage Forms (release controlling excipient); Table 8. Level 2 Component and Composition Changes for Modified Release Oral Solid Dosage Forms (release controlling excipient); and Table 9. Level 3 Component and Composition Changes for Modified Release Oral Solid Dosage Forms (release controlling excipient)

FIG. 5 contains Table 10. Schematic of areas of use within the commercial pipeline

FIG. 6 contains Table 11. Composition of Aspirin Formulations; Table 12. Composition of Prednisone Formulations; Table 13. Composition of Indomethacin Formulations; and Table 14. Compositions of Acyclovir Formulations.

FIG. 7 contains Table 15. This is a chart of the b 2^{nd} Derivative of Absorbance Versus Wavelength: Aspirin Formulations where formulations A3 (Yellow), A1 (Blue), and A2 (Red) contained increasing amounts of microcrystalline cellulose, the intensities around 1995 nm and 2055 nm reflect NIR to differentiate the formulations and the profiles of pure microcrystalline cellulose (Light Blue) and pure aspirin (Green) are also shown.

FIG. 8 contains Table 16. This is a chart of the 2^{nd} Derivative of Absorbance Versus Wavelength: Prednisone Formulations where formulations B3 (Yellow), B1 (Blue), and B2 (Red) contained increasing amounts of magnesium stearate, the intensities around 1705 nm, as well as the regions between 1725-1735 nm and 1775-1790 nm, reflect NIR to differentiate the formulations and the profile of pure magnesium stearate (Light Blue) is also shown.

FIG. 9 contains Table 17. This is a chart of the 2^{nd} Derivative of Absorbance Versus Wavelength: Indomethacin Formulations where formulations C3 (Yellow), C1 (Blue), and C2 (Red) contained increasing amounts of microcrystalline cellulose, as well as decreasing amounts of croscarmellose sodium, the intensities around 1890 nm and 1920 nm reflect NIR to differentiate the formulations and the profiles of pure microcrystalline cellulose (Light Blue) and pure croscarmellose sodium (Purple) are also shown.

FIG. 10 contains Table 18. This is a chart of the 2^{nd} Derivative of Absorbance Versus Wavelength: Acyclovir Formulations where formulations C3 (Yellow), C1 (Blue), and C2 (Red) contained increasing amounts of microcrystalline cellulose, as well as decreasing amounts of starch where the intensities around 2175 nm, 2205 nm, 2225 nm, 2250 nm, 2265 run, 2320 nm, 2345 nm, 2365 nm, as well as the regions between 2100-2130 nm and 2380-2420 nm, reflect NIR to differentiate the formulations, and the profiles of pure microcrystalline cellulose (Gray) and pure starch (Light Blue) are also shown.

FIG. 11 shows the 2nd derivative of absorbance versus wavelength for BP 87 (blue), ethanol (red) and MTBE (yellow). BP 87 is car gasoline from British Petroleum with an octane rating 87. Ethanol sample was 200 proof. BP 87, ethanol, and MTBE have different absorbance intensities around 1200 nm, 1400 nm, 1600 to 1800 nm, 2000 to 2200 nm and 2300 to 2500 nm. Ethanol and MTBE are example fuel additives.

FIG. 12 shows the NIR spectra of absorbance versus wavelength for BP 87 (blue), Mix A (red), Mix B (yellow), and Mix C (pink). BP 87 is car gasoline from British Petroleum with an octane rating 87. Mix A is BP 87:ethanol::10:1. Mix B is BP 87:MTBE::10:1. Mix C is BP 87:ethanol:MTBE::25:1:1. Ethanol was 200 proof.

FIG. 13 shows the score plot for ethanol, MTBE, BP 87, and Mix C. The score plot illustrates the first three principal components (PC), which denoted PC 1, PC 2, and PC 3. Mix C was a mixture of BP 87, ethanol and MTBE. Ethanol and MTBE are example fuel additives. Component ratios in Mix C are BP 87:ethanol:MTBE::25:1:1. Score plot separation between ethanol, MTBE, BP 87, and Mix C shows that PCA analysis of NIR data differentiated the formulated multi-component product Mix C and its components. Data underpinning this analysis from principle component analysis (PCA) are the same data from BP 87, ethanol, MTBE, and Mix C that underpin FIGS. 11 and 12.

FIG. 14 shows the 2nd derivative of absorbance versus wavelength for BP 89 (blue) and Mix D (red). Mix D is BP 89:water::10:1. Mix D reflects a petroleum product that has been tampered. These spectra have different absorbance intensities around 1200 nm, 1400 nm, 1600 to 1800 nm, 2000 to 2200 nm and 2300 to 2400

FIG. 15 shows the 2nd derivative of absorbance versus wavelength for ethanol (blue) and Mix E (red). Mix E is ethanol:water::10:1. Ethanol sample was 200 proof. Mix E reflects a petroleum product additive that has been tampered. These spectra have different absorbance intensities around 1200 nm, 1400 nm, 1800 to 2200 nm and 2300 to 2400 nm.

FIG. 16 shows the 2nd derivative of absorbance versus wavelength for BP 89 (blue), BP Diesel (red), Motor Oil (yellow), and kerosene (pink). BP 89 is car gasoline from British Petroleum with an octane rating 89. BP Diesel is car diesel from British Petroleum. These different spectra have different absorbance intensities around 1200 nm, 1400 to 1500 nm, 1600 to 1900 nm and 2100 to 2400 nm.

FIG. 17 shows the NIR spectra of absorbance versus wavelength for Shell 87 (blue), Shell 89 (red), and Shell 93 (yellow). These samples are car gasoline from Shell with an octane rating of 87, 89, and 93, respectively. NIR spectra reflect a rank order with octane rating.

FIG. 18 shows the NIR spectra of absorbance versus wavelength for NIR spectra of BP 93 (blue), Crown 93 (red), and Shell 93 (yellow). These samples are car gasoline with an octane rating of 93, but are from British Petroleum, Crown, and Shell, respectively. Spectra were sensitive to differences in sources. Crown 93 provided intensities that were the largest over the majority of wavelengths. Shell 93 intensity value exceeded BP 93 intensity value below about 1100 nm, between about 1050 and 1775 nm, and above about 2250 nm; otherwise, BP 93 values exceed Shell 93 values.

FIG. 19. Raman spectrum of sulfamethazine tablets that were granulated with corn starch paste. The spectral fingerprint reflects this unique sulfamethazine tablet formulation, which employed a traditional corn starch paste granulating agent.

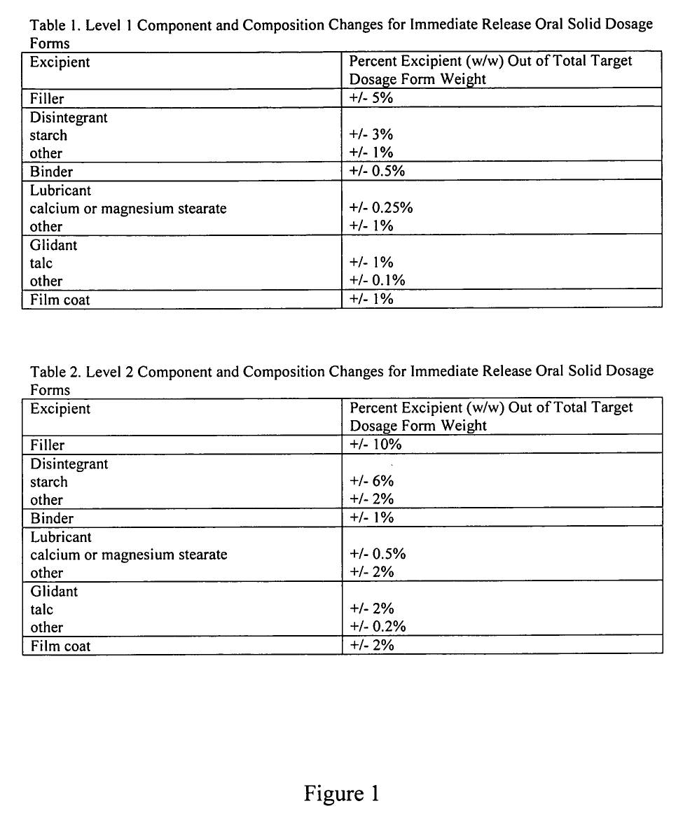

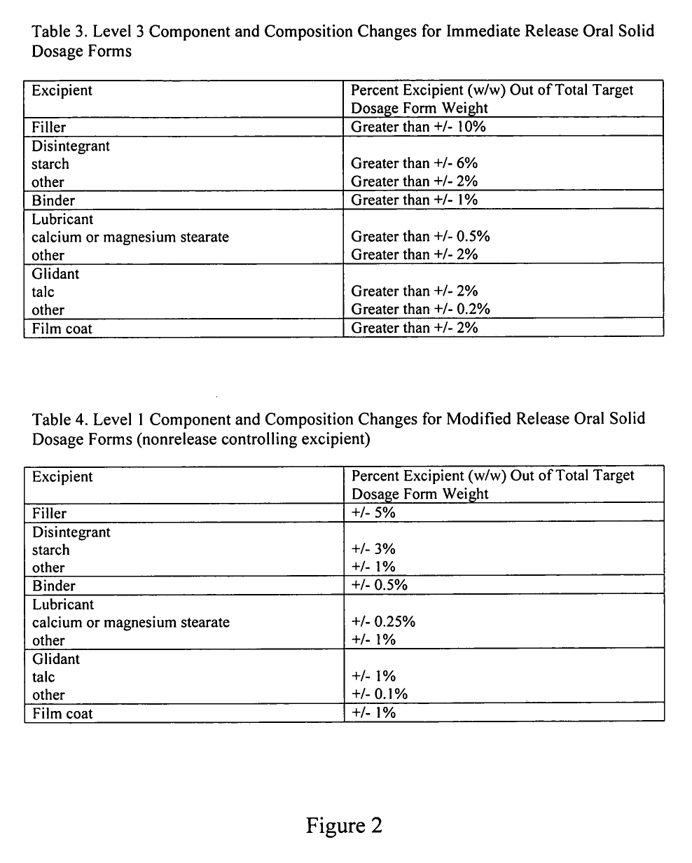

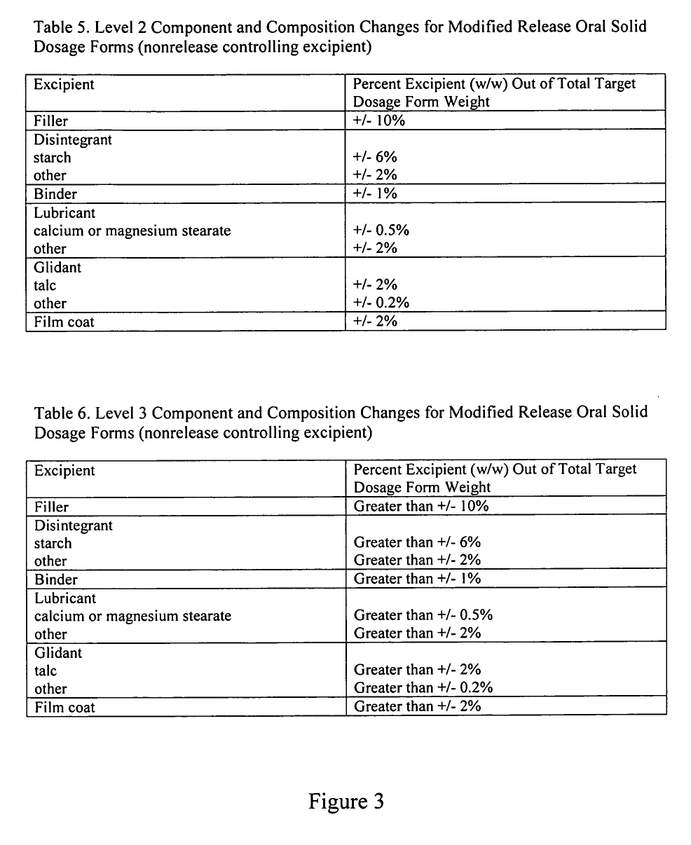

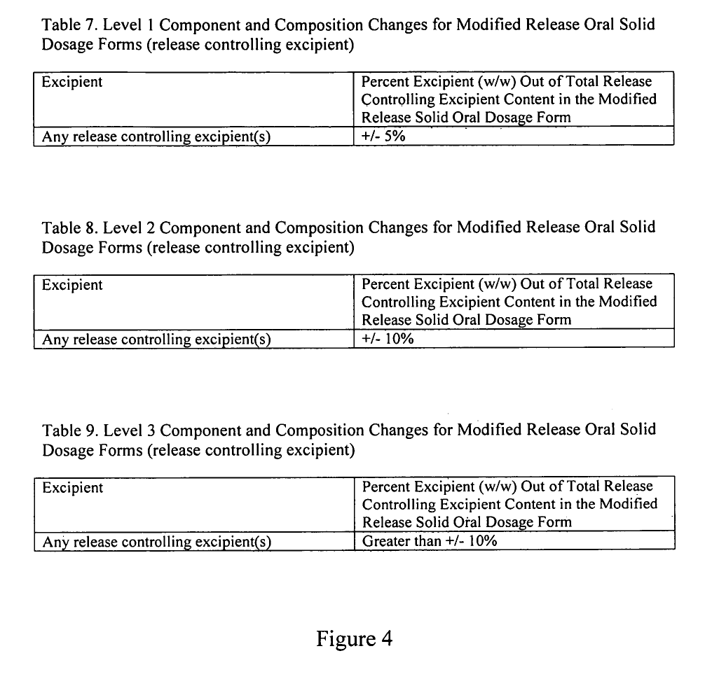

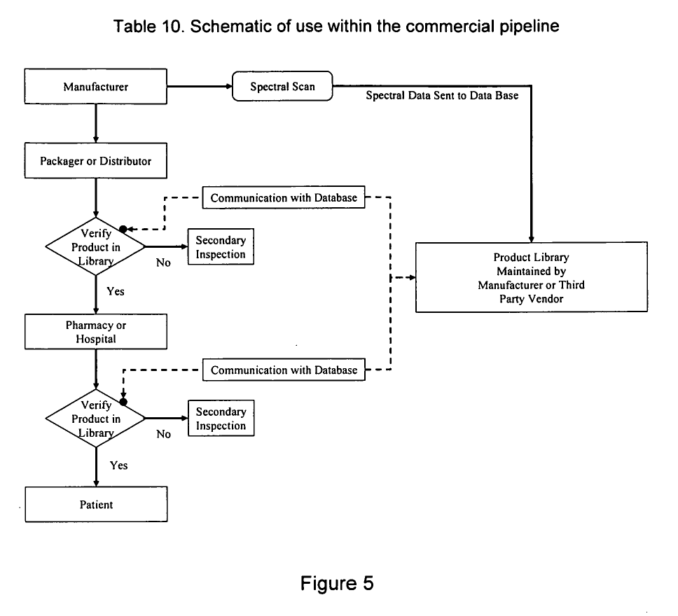

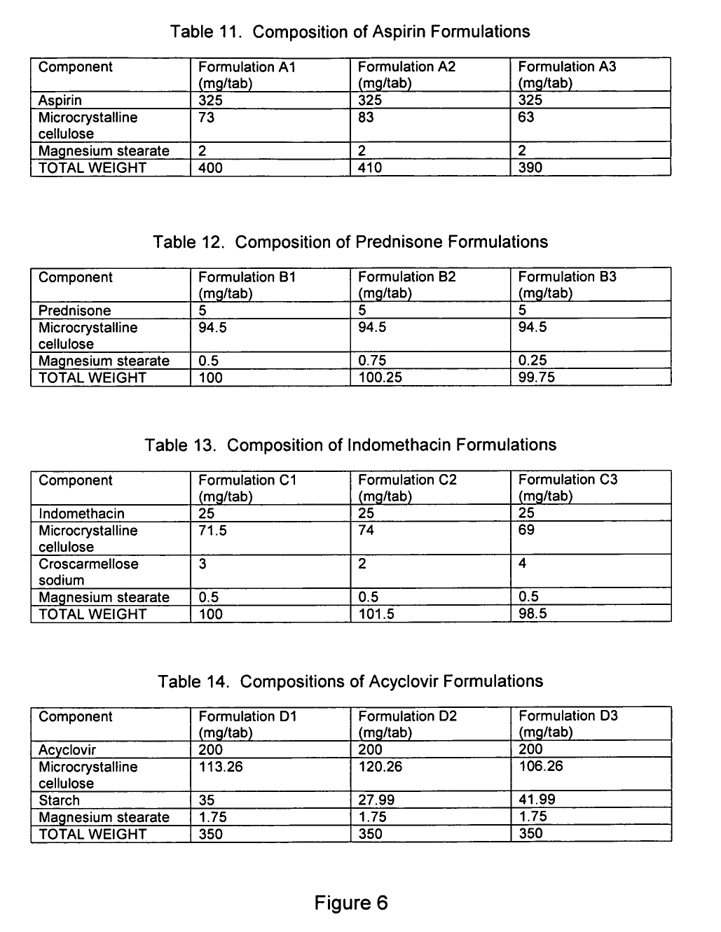

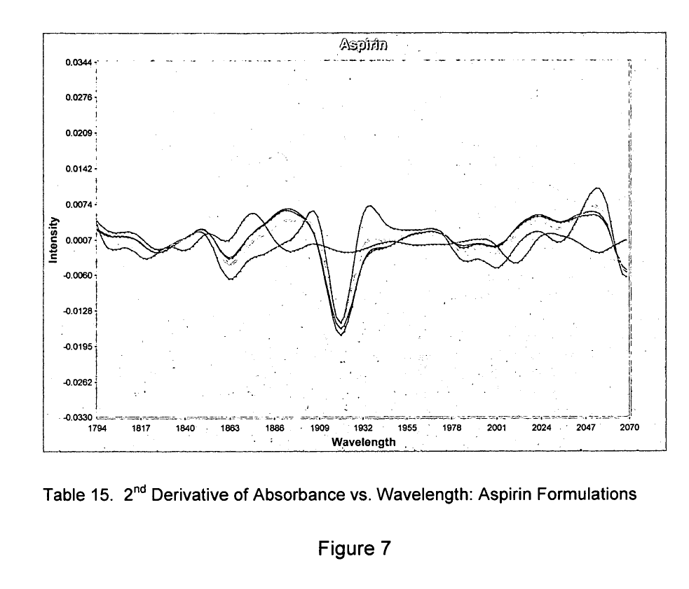

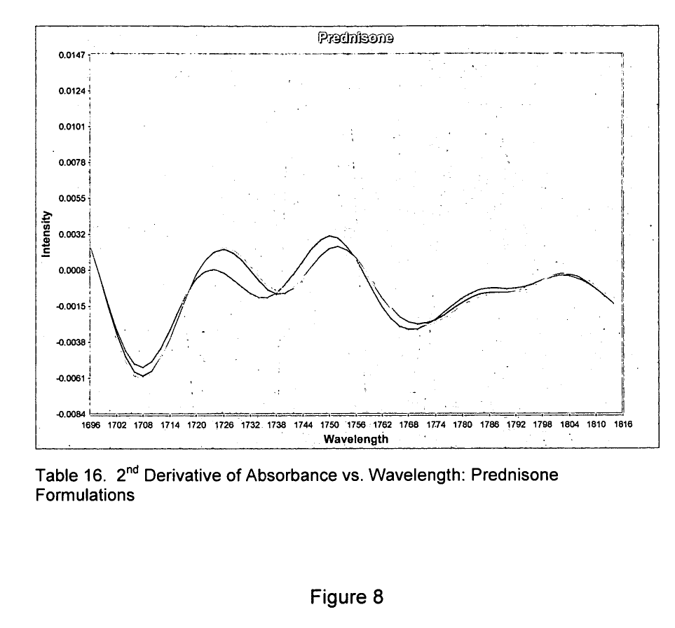

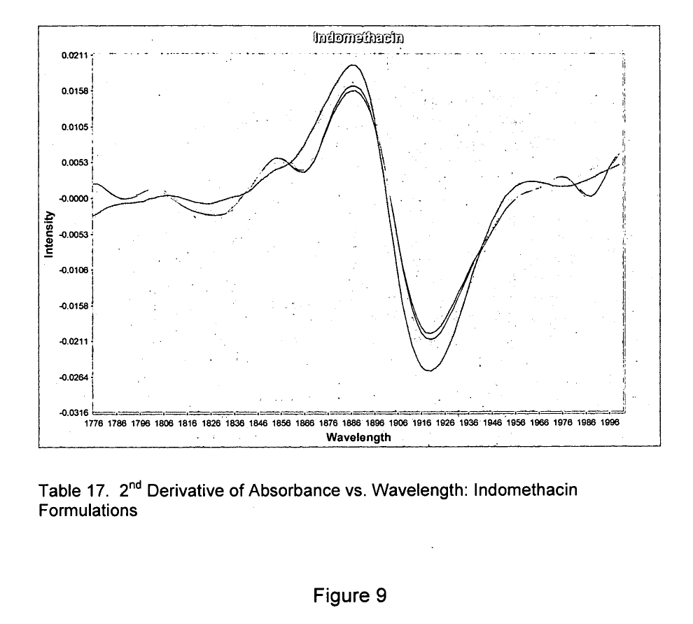

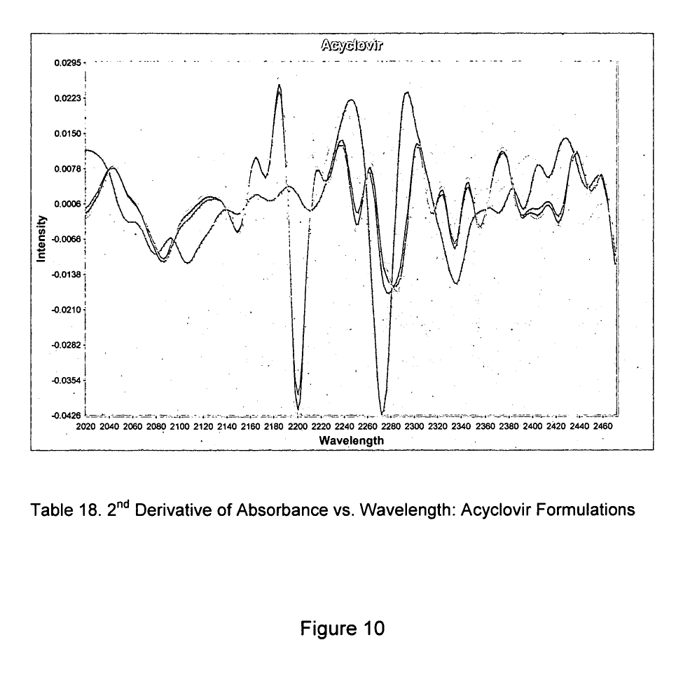

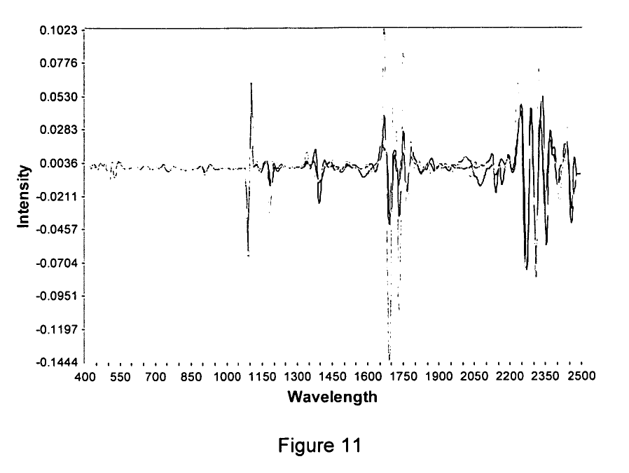

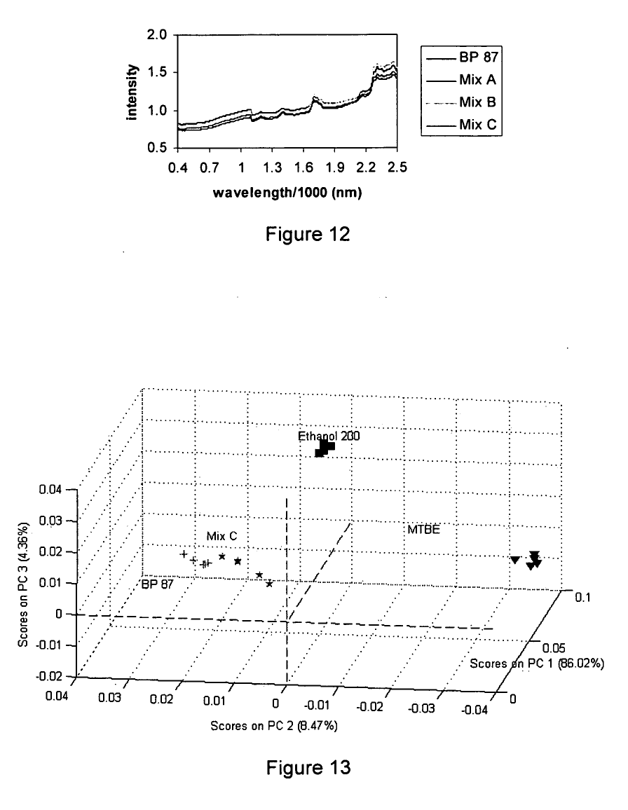

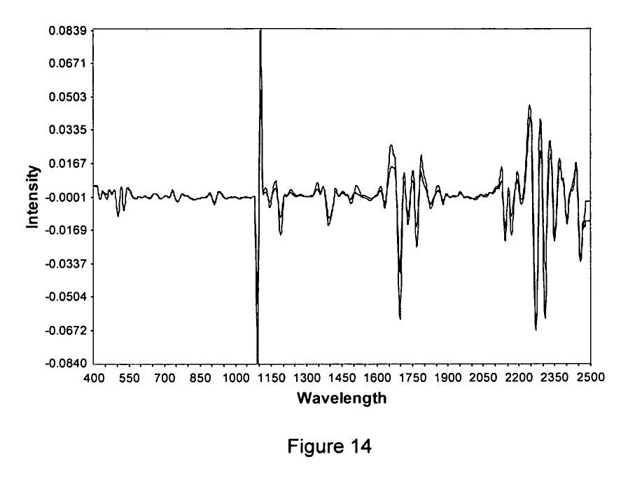

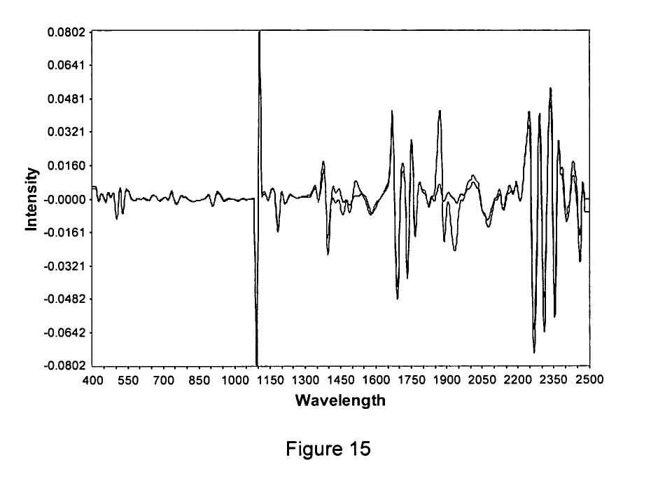

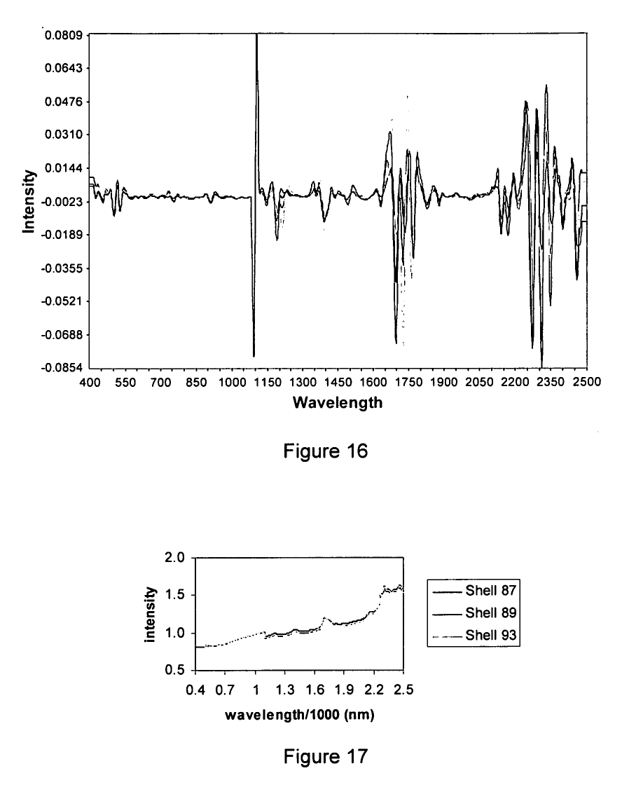

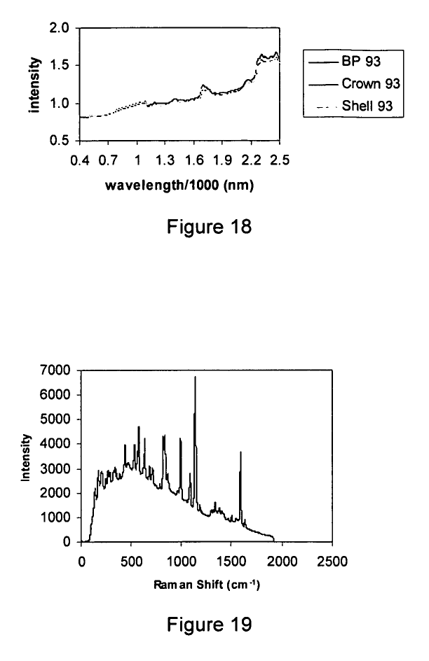

### DETAILED DESCRIPTION OF THE PREFERRED EMBODIMENTS

When used in this specification, the following words and phrases have the following meanings ascribed to them.

A “product” is any product that is amenable to formulation, in particular, amenable to variations in formulation, preferably, in which product formulations can tolerate certain variations without substantially affecting the performance characteristics of the product. The term product includes its formulation and implies a multi-component system, at least one of which components is varied to arrive at unique formulations, which can be distinguished, preferably through the use of spectral analysis.

A “pharmaceutical product” is a dosage form that comprises one or more therapeutic agents and one or more inactive ingredients.

“Therapeutic agents” include natural [biologics] drugs, synthetic drugs and nutraceuticals.

“Dosage forms” include, by way of example, tablets, capsules, powders, solutions, semisolids, suppositories, and lyophilized and milled powders, which may be reconstituted for injection.

“Drugs” include by way of example, atorvastatin calcium, azithromycin, amlodipine besylate, carbamazepine, ceftriaxone sodium, clozapine, epoetin alfa, filgrastim, indinavir sulfate, isotretinoin, lamivudine/zidovudine, leuprolide acetate, olanzapine, phenytoin sodium, somatropin, trovafloxacin mesylate, and warfarin sodium.

“Nutraceuticals” include by way of example, feverfew, ginkgo biloba, saw palmetto, St. John's Wort, chondroitin sulfate, Coenzyme Q10, glucosamine, growth hormones, L-carnitine, L-phenylalanine, shark cartilage, vegetable concentrates, chromium picolinate, manganese, biotin, riboflavin, and ascorbic acid.

The identity of a pharmaceutical product minimally denotes the therapeutic agent (or therapeutic agents) contained in the pharmaceutical product, the dose or concentration of each therapeutic agent in the pharmaceutical product, and manufacturer of the pharmaceutical product or any combination thereof.

“Counterfeit” denotes a product that has been mislabeled or otherwise adulterated with respect to identity and/or source. A product manufactured by an unapproved source is counterfeit.

A “counterfeit product” is a form of a product, which is counterfeit and which may or may not comprise desired active or inactive ingredients.

Authentic denotes not being counterfeit. An authentic product is a product that is not counterfeit.

A “dispensing error” is the dispensing of a pharmaceutical product which is not the pharmaceutical product specified in the dispensed prescription label.

A “product signature” is the spectral features obtained from a product or counterfeit product that is subjected to one or more spectral analyses. Methods of spectral analysis include near-infrared (NIR) spectroscopy, Raman spectroscopy, laser induced fluorescence (LIF) spectroscopy, and the like. An example of a product signature is the near-infrared spectrum of a specific lot of tablets that were produced by a specific manufacturer. Near-infrared spectrum is the absorption spectrum between 400 and 2500 nm.

A “library” of product signatures is a collection of product signatures.

An “inactive ingredient” is a component of a product which has no intended action leading to specific benefits (e.g., a therapeutic effect); inactive ingredients may also be referred to as excipients.

“Petroleum” is meant to encompass any product obtained directly or derived from fossil fuels and may or may not include synthetic components. Petroleum products, hence, can include, but are not limited to, gasoline, kerosene, jet fuel, charcoal, liquefied coal, heating oil, natural gas, motor oil, brake fluid, transmission fluid, polymers, blends, plastics, specialty chemicals, hydrocarbon gases, and the like.

In the method disclosed, covert NIR spectral fingerprints are embedded into each lot of a formulation by modifying formulation ingredient quantities while remaining within certain desirable or required ranges, e.g., regulatory agency allowable composition changes. Among the significant benefits of this approach are no need for an external tag and minimal regulatory burden. By intentionally varying excipient quantities within allowed ranges, for example, it is possible to encode a unique fingerprint into each product lot.

Pharmaceutical Products

Counterfeit drug products are an increasing problem, particularly because counterfeiting technology and counterfeiters have become more savvy. There remains a need to detect counterfeit drugs, including counterfeit drugs that are prepared and/or packaged similarly to the authentic pharmaceutical products. The invention includes but is not limited to the use of near-infrared (NIR), Raman LIF (laser induced fluorescence) spectroscopy and the like (all possible methods will hence be referred to as spectral methods or NIR methods) to identify the source of a drug in particulate dosage form and/or packaging. Advantages of NIR spectroscopy include its non-invasiveness, potential for low detection limits, rapidity of analysis (approximately 1 second), and minimal or no sample preparation. The vast majority of components commonly found in a pharmaceutical product exhibit a NIR spectrum.

Either or both the pharmaceutical packaging or dosage form can serve as taggants. For example, embossing, imprinting, printing, coating, dosage form size, and other identification methods can be applied to change the physical appearance of the dosage form (e.g. subtle changes in logo, use of an ultraviolet-dependent dye). Such approach can be used alone or in combination with other modifications of packaging and/or changes in the dosage form.

In a particular embodiment, the components in the dosage form can be varied, approximately batch-to-batch or with other [arbitrary] frequency, to provide a distinctive spectral signature for the product from that batch or lot.

Components of an oral particulate dosage forms (e.g. tablets or capsules) include the drug (active ingredient), impurities, drug degradents, fillers, disintegrants, binders, lubricants, glidants, colorants, flavoring agents, and coating materials. Some or all of the component levels can be modified, either batch-to-batch or with some other frequency, to yield a NIR spectra for the batch, a set of batches or other identification of lots.

Utilizing the procedures disclosed herein, the NIR spectra would not be identical for all product lots. A certain batch of product, or certain set of product batches, will have a unique composition, and hence a unique NIR spectra. The NIR spectrum of a particular lot is disclosed solely to those persons or entities selected by the manufacturer. Only the manufacturer (or agents of the manufacturer) will know the composition and associated NIR spectra of products from a particular batch or lot.

A suspect product can be subjected to NIR analysis and cross-referenced against the authentic NIR spectra. The association between authentic product's batch number and its NIR spectra, along with the ease of measuring NIR spectra, provides a basis to combat counterfeit drugs, to allow quality control and to identity lots for sundry other purposes.

Of added benefit, the association between NIR spectra and batch number(s) need not be provided to regulatory agencies or enforcement officials or health care providers, who could still perform field sampling and relay NIR spectra to the manufacturer. The manufacturer would then report back only the information of whether or not the sample matches the lot associated with that spectrum.

Furthermore, because the manufacturer would arbitrarily vary the variation of ingredients within the drug, past compositions (i.e. past NIR spectra of previous batches) would not be indicative of future compositions (i.e. future NIR spectra). Hence, a counterfeit effort would have no target product to counterfeit, without detection.

This approach employs the visible and NIR region of the electromagnetic spectrum. The NIR region typically includes wavelengths between about 700 nm (near the red in the visible spectrum) and about 3000 nm (near the infrared stretches of organic compounds). NIR absorbance peaks originate from overtones and combinations of the fundamental (mid-IR) bands and from electronic transitions in the atoms. C—H, N—H, and O—H bonds are responsible for most of the major absorbances. NIR spectrometry is used chiefly to identify or quantify molecules, including unique hydrogen atoms. NIR spectrometry is used to analyze for water, alcohols, amines, and any compounds containing C—H, N—H, and/or O—H groups. Many other bond combinations also provide NIR absorbance peaks. The visible region includes wavelengths between about 400 nm to about 700 nm. Absorbance peaks in this region can originate from conjugated pi electrons or aromatic moieties. Lakes and dies commonly used to give a dosage from a unique color typically absorb in this region of the electromagnetic spectrum.

While a pharmaceutical product typically has only one formula, and while manufacturers typically avoid manufacturing changes, this new approach to combat counterfeiting relies on the availability of several (i.e., more than one) formulas for the marketed product.

The U.S. Food and Drug Administration (FDA) allows for a range of component and composition changes in the manufacturing of products, without onerous regulatory requirements. The Center for Drug Evaluation and Research [CDER] publishes a series of monographs in its “Guidance for Industry” series. Its monographs “Scale-Up and Postapproval Changes: Chemistry, Manufacturing, and Controls: In Vitro Dissolution Testing and In Vivo Bioequivalence Documentation” [SUPAC monographs] deal with changes in various dosage forms and allowable changes in those dosage forms and reporting requirements relating to those changes. Monograph CMC 5 entitled “Immediate Release Solid Oral Dosage Forms” provides for certain changes in excipients in immediate release dosage forms in section “III. Components and Composition”. CMC 8 is the analogous document relating to modified release dosage forms.

Section III of these monographs relates to changes in excipients [but not active components] in drug products and categorizes changes in excipient levels into three groups. In the case of immediate release and modified release oral solid dosage forms, changes are denoted Level 1, Level 2, and Level 3 type changes. Level 1 changes are those that are unlikely to have any detectable impact on formulation quality and performance; regulatory filing documentation of a Level 1 change is limited to the Annual Report. Level 2 changes are those that could have a significant impact of formulation quality and performance. Level 3 changes are those that are likely to have a significant impact of formulation quality and performance. Tests and filing documentation for a Level 2 change and a Level 3 change each vary depending upon three factors: drug therapeutic range, drug solubility, and drug permeability. Tables 1-9 describe these manufacturing changes.

The present invention may be used within any countries public health infrastructure. In such cases, the skilled artisan is aware of obtaining and applying the appropriate regulatory guidelines in the manners referred to in the non-limiting exemplary embodiments provided herein. For example, in the United States, a Level 1 change requires less burdensome regulatory documentation, and represents one preferable example, relative to Levels 2 or 3 to vary formulation. Level 1 documentation requires one batch on long-term stability reported in an annual report. No additional dissolution documentation or in vivo bioequivalence documentation is required.

Hence, Level 1 changes are a preferable approach to tag authentic product, in order to avoid counterfeiting and facilitate the detection of counterfeiting through NIR spectroscopy. This approach avoids the use of a taggant that is fixed, or is one which is included in the formulation for the sole purpose as a taggant. Our approach to use the formulation's components themselves facilitates the tagging effort, and does so in a more subtle fashion, such that this tagging effort is less detectable and hence less prone to counterfeiting.

For example, for each immediate and modified release oral solid dosage forms, a filler can be modified by as much as 5% to provide a NIR spectra that tags the authentic product, and still qualify as a Level 1 change. Given the ability of NIR spectroscopy to resolve 1% and smaller differences in formulation, a unique tag can be fabricated by varying the filler level. Moreover, the number of unique NIR signatures can be generated in a multiplicative fashion by modulating two or more components (e.g. vary filler, disintegrant, and binder). Varying filler over 11 levels, disintegrant over 7 levels, and binder over 3 level can results in 231 unique NIR spectra, or more.

It should be noted that the number of distinct spectra that can be obtained and/or used is limited only be the sensitivity of the test equipment. As the ability of the apparatus to distinguish among varying spectral data sets becomes greater, the number of tags available will increase and the required degree of excipient change will diminish.

A further limit on the system relates to the quality of the manufacturing process. As process controls become even more precise and the desirability of having such controls becomes known, manufacturing practices will be held to tighter tolerances and a greater number of different spectral signatures will become available.

It is contemplated that the spectral signature of different product groups will be used for quality assurance purposes and will be able to identify product produced by different manufacturers, different manufacturing facilities of the same manufacturer, different production lines within a manufacturing facility, or product produced by different shifts on the same line in a manufacturing facility.

By varying the signature over time, environmental effects on the product in the field can be tracked and maintained in a database. Varying signatures over time also allows inherent determination of product dating and whether the product in question is a post-expiration product.

While NIR spectroscopy has some previous limited application in pharmaceutical analysis, it has not been applied to combat counterfeit drugs. Our approach employs the formulation itself to provide a dynamic tag system and NIR spectroscopy. It does not employ a fixed tag or a tag whose sole function is to serve as a tag, and thus subject to counterfeiting.

The approach of applying NIR spectroscopy to a manufacturing method that provides for a dynamic tag system is novel. Future tags are not anticipatable, and perhaps not practically detectable since formulation component(s) themselves provide the tag. The manufacturing method makes use of regulatory mechanisms that were implemented in 1995 (immediate release products) and 1997 (modified release products), in order for the tag system to be dynamic, yet viable from a regulatory point of view.

NIR spectrometry is advantageous in terms of time and disposables. Analysis times are very short (e.g., 1 sec). It is sensitive to multi-component variables, as planned in the described approach. There is essentially no sample preparation. NIR is noninvasive and nondestructive. No reagents are required. Detection limits can be very low.

Also, because this device can detect the drug type and its dose this could also be used to greatly minimize the possibility of the pharmacist dispensing the wrong drug and the wrong dose of a drug

In one embodiment, a unique NIR signature is engineered into the packaging as well as the product, much like a certificate of authenticity on a CD or commercial software package. A company could have several hundred types and assign a lot number to each one.

It should also be noted that varying the formulation to evade and detect counterfeiting is one approach in the application of spectral methods. Another approach does not make use of the intentional periodic variation of the formulation as described above.

Various applications for this technology include, but are not be limited to methods to evade and detect counterfeit drug products (and counterfeit drug substances and counterfeit excipients); methods to assure drug product distribution integrity (and drug substance integrity and excipient integrity) at different levels for monitoring drug product distribution, such as by pharmaceutical manufacturers, pharmaceutical wholesalers, pharmaceutical distributors, and pharmacies (who would be interested in detecting counterfeit drug products and in assuring the correct product is being dispensed.), pharmaceutical re-packagers, and FDA field monitoring, as well as regulators in other countries.

A typical example application is in the detection of counterfeit drug products by FDA field inspectors and/or health care workers (e.g. pharmacist, nurse) working with the manufacturer of the authentic product. FDA field inspectors and/or health care workers would obtain the NIR spectrum of suspect products and relay the spectrum data to the manufacturer of the authentic product. Agents of the manufacturer of the authentic product could also inspect samples in the field by obtaining NIR spectrum of suspect products.

Another typical example of its use would be by pharmacies employing NIR to avoid accidental overdose or misadventure in pharmacy dispensing by assuring that the dispensing robot dispenses the correct product or to assure the dispensed product is the correct product with semi-automated dispensing devices where the NIR is built into tablet/capsule counter.

Petroleum Products

The invention can also generally be applied to a method for assuring petroleum product identity as material progresses through the processing and delivery system.

Within the distribution system of petroleum products, there is a need to assure petroleum and petroleum product identity. Example scenarios include the need to identify and differentiate authentic and counterfeit petroleum products, and a need to assure the dispensing of the correct petroleum product to vendors and consumers. There also exists the need to authenticate the source and processing of petroleum after they are distributed further down the processing and delivery system, including enforcement of anti-dumping.

This present disclosure relates to a dynamically variable covert marking system for petroleum products. The marking system is inherent in the petroleum itself, is present in each and every petroleum product, and cannot be modified after manufacture. Petroleum additives in the petroleum product are changed over time, the spectral signature of the petroleum product is determined by the producer (the “reference”) and an unknown sample has its spectral signature compared to the spectral signature of the reference. The match or lack of match of the two spectral signatures determines whether or not the petroleum product was produced by that manufacturer, and, if produced by that manufacturer, which batch, lot, plant, plant component, or time of manufacture, etc. the set of petroleum products the sample belongs to.

The present method allows a manufacturer to “fingerprint” or “authenticate” a selected quantity of petroleum product, be it by batch, by production location, by production line, by date of manufacture, etc. The word “authenticate” as used herein means a method of measuring any parameter or set of parameters associated with a product that allows an observer to determine some fact relating to the product and thereafter to compare that fact to a reference standard. Information developed may be used to identify the petroleum product and its origin.

Due to its flexibility in determining the number of petroleum product manufactured with a single fingerprint, the manufacturer can use the method for quality assurance or for other internal control purposes. The fingerprint can be used in conjunction with packaging information to confirm lots, batches or any other identifying information required by the manufacturer as the petroleum product moves through the supply chain.

These benefits are obtained by monitoring petroleum product identity of petroleum products within the petroleum product distribution system, and are achieved though the use of, for instance, NIR techniques, optionally in connection with one or more other technologies. The combination of these techniques and approaches make for a rapid and accurate approach to assure petroleum and petroleum product identity, as well as a method to prevent the petroleum product from being counterfeited.

The methods also provide an efficient technique for fingerprinting petroleum as to the manufacturer and production batch. Most significantly, the techniques disclosed provide for an undetectable fingerprint inherent in each petroleum product and for methods of determining the fingerprint of a sample petroleum product without disclosing the undetectable fingerprint other than to persons of the manufacturer's choice.

The herein disclosed approach is to apply NIR spectroscopy with a manufacturing method that provides for a dynamic tag system. Future tags are not anticipatable and perhaps not practically detectable since petroleum product formulation component(s) themselves provide the tag. The method may be modified as regulatory or equipment changes occur to maintain or increase the number of signatures that may be used.

NIR spectrometry is advantageous in terms of time and disposables. NIR is noninvasive and nondestructive. Analysis times are very short (e.g., 1 sec) and no reagents are required. The procedure is highly sensitive and is able to can perform multi-component analyses, as disclosed herein. Using the disclosed procedures, there is essentially no sample preparation.

Covert NIR spectral fingerprints are embedded into each lot of a petroleum product by modifying formulation ingredient quantities. Among the significant benefits of this approach are no need for an external taggant, although such external taggants are not excluded. By intentionally varying petroleum product formulation quantities, it is possible to encode a unique fingerprint into each product lot.

Given the increased value of petroleum product over time, counterfeit petroleum product appear to be an increasing problem. There remains a need to detect counterfeit petroleum products, including counterfeit petroleum product that are similar to the counterfeited petroleum product (i.e., authentic products). The invention includes but is not limited to the use of infrared, near-infrared (NIR), Raman, LIF (laser induced fluorescence) spectroscopy, UV/visible spectroscopy, and the like (all possible methods will hence be referred to as spectral methods) to identify the source of a petroleum in particular petroleum product. Advantages of NIR spectroscopy include its non-invasiveness, potential for low detection limits, rapidity of analysis (approximately 1 second), and minimal or no sample preparation. The vast majority of components in petroleum product exhibit a NIR spectrum.

Either or both the petroleum product packaging/delivery or petroleum product can serve as taggants. For example, methods can be applied to change the physical appearance of the delivery vehicle of the petroleum product. Such approach can be used alone or in combination with other modifications of packaging and/or changes in the petroleum product.

In a particular embodiment, the components in the petroleum product can be varied, approximately batch-to-batch or with other arbitrary frequency, to provide a distinctive spectral signature for the product from that batch or lot.

Other examples of petroleum products include, but not limited to, gasoline, oxygenated fuels, reformulated gasoline, and alternative fuels. Petroleum products include liquefied or compressed natural gases (e.g. methane, propane), Fischer-Tropsch fuels, and biodiesel fuels (e.g., vegetable oil). Petroleum products also refer to gasolines for different types of vehicles (e.g., cars, aviation planes). Reformulated gasoline (RFG) is gasoline blended to burn cleaner and reduce smog-forming and toxic pollutants. Reformulated gasoline (RFG) is gasoline that is blended such that it significantly reduces volatile organic compounds and air toxics emissions relative to conventional gasoline. Methyl Tertiary-Butyl Ether (MTBE) and ethanol (EtOH) represent the majority of oxygenate use in RFG. Oxygenates will probably continue to be used in conventional gasoline, primarily as octane extenders. Oxygenates are fuel additives (alcohols and ethers, such as ethanol and MTBE) that contain oxygen which can boost gasoline's octane quality, enhance combustion, and reduce exhaust emissions. Car gasoline components include aromatics, olefins, benzene, sulfur, MTBE, and ethanol. A component of aviation gasoline is tetra-ethyl lead, which is not present in gasoline for cars. The main petroleum for aviation gas is alkylate, which is a mixture of isooctanes, and may include reformate. Other additives to petroleum products also include ethanol, acetaldehyde, MBTE, ethyl tertiary butyl ether, and methanol.

Additives typically are incorporated into petroleum products to: Reduced Vapor Pressure (e.g., lower evaporation, refueling and running loss elimination); Modulate flammability/reactivity (e.g., reduce reactivity of vehicle emissions, improve flame speed in fuels); Reduced Aromatics (e.g., lower hydrocarbon emissions, reduce engine deposits, lower exhaust as reactivity); Improve Performance (e.g., reduce engine deposits, lower octane requirement increase, enhance catalyst performance); Provide Oxygenation (e.g., reduce carbon monoxide emissions, improve octane quality).

Some or all of the component levels can be modified, either batch-to-batch or with some other frequency, to yield a NIR spectra for the batch, set of batches or other identification of lots.

Utilizing the procedures disclosed herein, the NIR spectra would not be identical for all product lots. A certain batch of product, or certain set of product batches, will have a unique composition, and hence a unique NIR spectra. The NIR spectrum of a particular lot is disclosed solely to those persons or entities selected by the manufacturer. Only the manufacturer (or agents of the manufacturer) will know the composition and associated NIR spectra of products from a particular batch or lot.

A suspect product can be subjected to NIR analysis and cross-referenced against the authentic NIR spectra. The association between authentic product's batch number and its NIR spectra, along with the ease of measuring NIR spectra, provides a basis to combat counterfeit petroleum product, to allow quality control and to identity lots for other purposes.

Furthermore, because the manufacturer could arbitrarily vary, the variation of ingredients within the petroleum product, past compositions (i.e., past NIR spectra of previous batches) would not be indicative of future compositions (i.e., future NIR spectra). Hence, a counterfeit effort would have no target product to counterfeit, without detection.

In one of its embodiments, the comparison data needed to reference the sample against authentic product is supplied to the field, e.g., a pharmacy, hospital, retailer, warehouse, hardware store, petroleum station, other dispensing authority, to allow them to determine the authenticity of a product in the field.

In an alternative embodiment a more secure system is utilized, where the manufacturer maintains a comprehensive database of all variations of the product over time and allows access to that database to authorized users to allow a multiplicity of data to be retrieved about the particular product being tested.

In a yet more secure variation, the manufacturer's central database reports only a yes:no answer as to whether the product is counterfeit or outdated, allowing the manufacturer to track the movement of its product through the supply chain but still maintain control over the dissemination of the information.

It is also contemplated that a central repository of such data may be set up by industry or government to track and maintain the purity of products, particularly, medicaments, used by its citizens.

The following example is presented in order to more fully illustrate the preferred embodiments of the invention. It should in no way be construed, however, as limiting the broad scope of the invention.

### EXAMPLE 1

Materials. The following drug substances and excipients were used as received: aspirin (Sprectrum, Gardena; Calif.), prednisone (Sigma; St Louis, Mo.), indomethacin (Spectrum; Gardina, Calif.), acyclovir (Spectrum; Gardena, Calif.), microcrystalline cellulose (Emocel 90M, Mendell; Patterson, N.Y.), magnesium stearate (Spectrum, Gardina, Calif.), croscarmellose sodium (FMC Biopolymer; Princeton, N.J.), starch (Lycatab C, Roquette; Lestrem, France), and lactose monohydrate (Super-tab, The Lactose Company; Hawera, New Zealand),

Formulation Methods. Three tablet formulations were designed and evaluated for each of four drugs, such that 12 formulations were made. The four drugs were aspirin, prednisolone, indomethacin, and acyclovir, and are denoted as drug A, B, C, and D, respectively. The drugs differ in their therapeutic uses, physicochemical properties, spectral properties, and dose ranges. For each drug, three tablet formulations were fabricated. Tables 1-4 describe the composition of the 12 formulations and refer to formulations A1, A2, A3, B1, etc. In each table, the first formulations is denoted the reference formulation (i.e. A1, B1, C1, and D1 are reference formulations). For each drug, the formulations were varied within the SUPAC level 1 tolerances by varying one or more excipients, relative to the reference formulation, resulting in the second and third formulations (i.e. formulations A2 and A3 were variants for formulation A1; formulations B2 and B3 were variants for formulation B1).

Variant formulations were attained through the following changes, relative to the reference. For aspirin, microcrystalline cellulose was increased and decreased. For prednisone, magnesium stearate was increased and decreased. For indomethacin, microcrystalline cellulose and croscarmellose sodium were simultaneously varied. For acyclovir, microcrystalline cellulose and lactose monohydrate were simultaneously varied. In some cases the tablet weight changed.

Near-IR Methods. The formulations were scanned and analyzed by Foss NIRSystems Rapid Content Analyzer™. The following test conditions were used. Samples were placed into sealed glass scintillation vials and scanned in reflectance mode; each sample was scanned 62 times and averaged into one spectrum; the wavelength range was 400 nm to 2500 nm with samples collected every 2 nm. The raw spectral data were converted into absorbance and 2^{nd} derivative values using Foss's Vision software package.

Since the active components or components in the drug dosage for are not varied in the disclosed system, it is apparent that the system is not constrained by the type of active ingredient or combination of actives. It is within the ability and choice of a skilled artisan to chose the inactive ingredient or ingredients to vary in developing the various spectral profiles of a drug product regardless of its active ingredients.

It should also be apparent that the system is independent of the quantity of active ingredient in the dosage form and that the system may actually be used to provide a signature to distinguish among varying dosage forms.

While the system is not dependent upon the identity of the active ingredient or ingredients, it is recognized that the system may be most useful in conjunction with certain drugs that are more likely to be subject to theft, abuse or counterfeiting.

### EXAMPLE 2

Materials: The following petroleum products and petroleum components were used as received: BP 87, BP 89, BP 93, which are car gasoline from British Petroleum (Ellicott City, Md.) with an octane rating of 87, 89, and 93, respectively; Crown 93, which is car gasoline from Crown (Ellicott City, Md.) with an octane rating of 93; Shell 87, Shell 89, Shell 93, which are car gasoline from Shell (Ellicott City, Md.) with an octane rating of 87, 89, and 93, respectively; ethanol (200 proof; AAPER Alcohol and Chemical Co.; Shelbyville, Ky.); methyl tertiary-butyl ether [MTBE] (EMD Chemicals Inc.; Gibbstown, N.J.); BP Diesel, which is car diesel from British Petroleum (Ellicott City, Md.); motor oil (SuperTech 10W-30 SAE; WalMart; Bentonville, Ark.); kerosene (Crown; Ellicott City, Md.)

Formulation Methods. Materials were used as received. Mix A, B, and C were formulated. Mix A is BP 87:ethanol::10:1. Mix B is BP 87:MTBE::10:1. Mix C is BP 87:ethanol:MTBE::25:1:1. Ethanol and MTBE are example petroleum product additives. Mix A, B, and C reflect example petroleum products that provide a spectral signature based upon component composition. Mix D and E were also fabricated as tampered, adulterated, or counterfeit petroleum products or tampered, adulterated, or counterfeit petroleum product additives. Mix D is BP 89:water:10:1. Mix D reflects a petroleum product that has been tampered. Mix E is ethanol:water::10:1. Mix E reflects a petroleum product additive that has been tampered. Mixture ratios are by volume/volume.

Near-IR Methods: The formulations were scanned and analyzed by Foss NIRSystems Rapid Content Analyzer™. The following test conditions were used. Samples were placed into sealed glass scintillation vials and scanned in reflectance mode; each sample was scanned 62 times and averaged into one spectrum; the wavelength range was 400 nm to 2500 nm with samples collected every 2 nm. The raw spectral data were converted into absorbance and 2nd derivative values using Foss's Vision software package.

It is apparent that the system is not constrained by the category or type of petroleum product or combination of actives. It is within the ability and choice of a skilled artisan to choose the additive or additives to vary in developing the various spectral profiles of a petroleum product regardless of category or type of petroleum product.

While the system is not limited by category or type of petroleum product, it is recognized that the system may be most useful in conjunction with certain petroleum products that are more likely to be subject to theft, abuse, or counterfeiting.

We claim:

1. A method of labeling a product having one or more components comprising varying an amount of at least one of the one or more components and generating a product signature of the product having the varied amount of the at least one of the one or more components.

2. The method of claim 1 wherein the product signature comprises a spectral signature.

3. A batch identification method for determining the source of a product from among a plurality of production batches of the product, where the product comprises one or more components, comprising changing an amount of at least one of the one or more components among different batches of the product produced, the variation being at least sufficient to distinguish the difference in a spectral signature of each batch of product produced.

4. The method of claim 1, wherein the component whose amount is varied is an inactive ingredient.

5. The method of claim 1, wherein the component whose amount is varied is selected from the group consisting of a filler, a disintegrant, a binder, a lubricant, a glidant, a film coat, an additive, a solvent and combinations thereof.

6. The method of claim 4, wherein the inactive ingredient is the filler.

7. The method of claim 3, wherein the amount changed is in the range of about 5 percent based on a total weight of the product.

8. The method of claim 4 in which the inactive ingredient is the binder.

9. The method of claim 3, wherein the amount changed is in the rage of about 0.5 percent based on a total weight of the product.

10. The method of claim 4 in which the inactive ingredient is the disintegrant.

11. The method of claim 3, wherein the amount changed is in the range of about 3 percent based on a total weight of the product.

12. The method of claim 1 wherein the product is a food, baby formula, medical device, pesticide product, jewelry, textile, apparel, shoe, purse and any other single designer fashion items, cosmetics, paint, nutraceuticals (e.g., fish oils), perfumes, sunglasses, auto parts, aircraft parts, and plastics.

13. The method of claim 1 wherein the product is a petroleum product or petroleum byproduct.

14. The method of claim 1 wherein the product is a fuel or fuel derivative.

15. The method of claim 1 wherein the product is a finished non-fuel petroleum product or byproduct thereof.

16. The method of claim 1 wherein the product is a petrochemical feedstock or byproduct thereof.

17. A system for verifying the authenticity of a product comprising the steps of:
manufacturing more than one batch of a product, each batch having a reference spectral signature;
inputting each of the reference spectral signatures into a database;
scanning a sample product to produce a scanned spectral signature;
comparing the scanned spectral signature to each of the reference spectral signatures; and
reporting the results of the comparison, wherein the authenticity of the sample product is verified by the scanned spectral signature being equivalent to at least one of the reference spectral signatures.

18. The system of claim 11 in which the reference spectral signature and the scanned spectral signature are NIR spectra.

19. The system of claim 11 in which the spectral signature of the scanned product is transmitted to a database of spectral signatures of authentic products, the scanned spectral signature is compared to the authentic spectral signatures in the database and reporting the results of the comparison are reported.

20. A set of groups of a product having one or more active ingredients and one or more inactive ingredients, wherein the one or more active ingredients and the one or more inactive ingredients are the same in each group in the set, and an amount of at least one of the one or more inactive ingredients is different in at least one group of the set as compared to the other groups in the set, wherein the amount is detectable in a near-infrared (NIR) spectra of the product in the at least one group of the set as compared to a near-infrared (NIR) spectra of the product of the other groups of the set.

21. A member of a set of groups of a product having one or more components, wherein the one or more components are the same in each group in the set, and an amount of at least one of the one or more components is different in at least one group of the set as compared to the other groups in the set, wherein the amount is detectable in a spectral signature of the product in the at least one group of the set as compared to a spectral signature of the product of the other groups of the set.

22. A method of manufacturing a labeled product having one or more components comprising modifying the quantity of at least one of the one or more components in a first product to make a second product, wherein the modification is detectable in an near-infrared (NIR) spectra of the second product as compared to a near-infrared (NIR) spectra of the first product, wherein said second product is the labeled product.

23. A labeling system for a product having one or more components comprising modifying a quantity of at least one of the one or more components in a first product to make a second product, wherein the modification is detectable in a near-infrared (NIR) spectra of the second product as compared to a NIR spectra of the first product, wherein said modification comprises the label.

24. A method of determining the identify of a product comprising the steps of:
obtaining a product signature of a product and
comparing said product signature to a reference product signature of a reference product, wherein said reference product signature is a member of a library, wherein the product is identified as the reference product if the product signature of the product is the same as the reference product signature.
